(19) United States
(12) Patent Application Publication
(10) Pub. No.: US 2010/0211566 A1
(43) Pub. Date: Aug. 19, 2010

(54) ENTITY-BASED SEARCH RESULTS AND CLUSTERS ON MAPS

(75) Inventors: Joy Ghanekar, San Francisco, CA (US); Jerry Cheng, Mountain View, CA (US); Edward Stanley Ott, IV, Palo Alto, CA (US); Marc Eliot Davis, San Francisco, CA (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/489,935

(22) Filed: Jun. 23, 2009

Related U.S. Application Data
(60) Provisional application No. 61/152,663, filed on Feb. 13, 2009.

(51) Int. Cl. G06F 17/30

(52) U.S. Cl. 707/724; 707/E17.014; 707/E17.032

(57) ABSTRACT

Techniques are described for providing geographically-related search results in map interfaces that are derived with an understanding of the intent behind the user's query, and the abstract entities to which the query maps.

### RELATED APPLICATION DATA

The present application is claims priority under 35 U.S.C. 119(e) to U.S. Provisional Patent Application No. 61/152,663 for ENTITY-BASED SEARCH RESULTS AND CLUSTERS ON MAPS filed on Feb. 13, 2009 (Attorney Docket No. YAHIP206P/Y05559US00), the entire disclosure of which is incorporated herein by reference for all purposes.

### BACKGROUND OF THE INVENTION

The present invention relates to presentation of search results in map interfaces.

Conventional map search products and services allow users to search for things at or near a specified location, e.g., things in a particular category such as local businesses or points of interest. This typically involves identifying matching results within a specified radius of a geographic location (e.g., latitude and longitude) that correspond to the particular category. The results are then presented on a map. In addition to distance, the results presented on the map may be biased in any of a number of ways such as, for example, with reference to relevance and/or quality metrics (e.g., ranking or rating).

Unfortunately, these conventional approaches are fairly constrained with regard to the types of results that can be presented for a given search query.

### SUMMARY OF THE INVENTION

According to the present invention, various methods, apparatus, systems, and computer program products for providing search services are provided. According to a specific embodiment, a search query entered by a user on a remote computing device is received. One or more entities are determined corresponding to one or more abstract concepts represented by the search query. Each entity has a geographic component. One or more possible user intents represented by the search query are determined. One or more data sources are identified including search results data corresponding to a first one of the entities and a first one of the possible user intents. A plurality of search results are retrieved responsive to the search query, and relating to the first entity, and the first possible user intent from the one or more data sources. Representations of the search results are related to map information with reference to a specific geographic location. The representations of the search results and the map information are transmitted to the remote computing device for presentation to the user.

A further understanding of the nature and advantages of the present invention may be realized by reference to the remaining portions of the specification and the drawings.

### BRIEF DESCRIPTION OF THE DRAWINGS

FIGS. 1-7 are mobile device screenshots illustrating presentation of search results in accordance with specific embodiments of the invention.

FIG. 8 is a flowchart illustrating the operation of a specific embodiment of the invention.

FIG. 9 is a simplified diagram of a computing environment in which embodiments of the invention may be implemented.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

Embodiments of the present invention provide users of search products and services with answers, rather than just web links. This is enabled by an understanding of the intent behind a user query. Intent is determined by identifying one or more abstract concepts, i.e., “entities,” associated with or underlying the query. According to various embodiments, it is also determined whether the entities to which a given query maps have associated geographic location (also referred to herein as geo-location) components, and, if so, representations of the identified entities are displayed on a map with reference to such geo-location components.

Thus, for example, if a user enters the query “weather,” i.e., a type of data that is location sensitive or “geo-related,” local weather conditions may be presented on a map which includes the user's current location (e.g., as determined with reference to GPS data or a nearby cell tower location). In another example, a user might enter the query “entertainment,” in response to which nearby locations (e.g., movie theaters, night clubs, etc.) offering entertainment-related events currently going on or scheduled to occur within some time period could be presented. In yet another example, the query “UA 1795” would be recognized as an airline flight number, in response to which a representation of the current location of that flight (and its status) could be presented. A variety of relevance factors may be considered in determining the user's intent and identifying the most relevant geo-related information for display. The manner in which this may be accomplished in accordance with specific embodiments of the invention is described below.

Embodiments of the present invention are intended for contexts in which location data are associated with search result types (i.e., entities or concepts), and provide search results derived with the understanding of the intent behind the user's query, and the abstract entities to which the query maps. This enables geographically-related search services that go far beyond the static assumptions which constrain conventional approaches to map search, e.g., the assumption that a user is only searching for business listings. Instead, by divining intent and by understanding the abstract concepts underlying search terms, the present invention can provide search results from a much richer set of data sources that more effectively provide what the user is actually looking for.

Yahoo! Mobile includes initiatives related to a functionality and feature set referred to as oneSearch. oneSearch provides search services which aggregate and present all of the best search results clustered by type. A short description of the operation of the oneSearch query processor may be instructive for understanding the map overlays generated in accordance with the invention in that there is a common underlying information paradigm on which both rely. In this example, a user enters the query “apple.” In addition to text in or associated with web pages and documents, the term “apple” can be mapped to a number of abstract ideas, real world objects, and digital objects and media. Collectively, these things are referred to herein as “concepts” or “entities.” oneSearch takes the string “apple” and performs a disambiguation to determine at least some of the possible entities “apple” might represent, e.g., the company, the fruit, the record label, etc., each of which may then be mapped to one or more result types.

For example, if the entity is Apple® the company, the different result types might include geographic results (e.g., company or store locations), stock price, news stories (e.g., text and video), as well as conventional web and mobile web links. oneSearch then renders clusters of result types based on the entity or entities identified in the disambiguation phase and their respective mappings to result types. Additional information about the operation of oneSearch, including entity (concept) identification and disambiguation, may be obtained with reference to U.S. Patent Publication No. US 2008-0168052 A1 entitled CLUSTERED SEARCH PROCESSING, the entire disclosure of which is incorporated herein by reference for all purposes.

In addition to understanding the intent behind a user query, and the abstract concepts to which a query might relate, the presentation of geo-related information in accordance with various embodiments of the invention may be informed by an understanding of who the user is, where the user is, the current time, and what the user's query relates to, i.e., where/when/who/what (W4) metadata. More generally, such spatial, temporal, social, and/or topical metadata may be leveraged to bias presentation of geo-related information in accordance with the invention.

Embodiments of the present invention may be thought of as map rendering of intent, and possibly one or more entities (including clusters of related entities) mapping to that intent, relative to a particular geographic location or region. The intent model underlying such embodiments may employ a wide variety of information to determine intent, and to thereby understand the most relevant mappings, i.e., to identify the most relevant information to present on the map in view of the user's intent. A straightforward linguistic or text analysis of a query may provide a first level of intent determination. However, as will be discussed below, a wide variety of other information may be incorporated into or interpreted by an intent model for use with embodiments of the invention.

The example of a query for “weather” is one which illustrates a mapping of intent to a geographic location that may not involve identification of or mappings to any particular entity or entities. That is, the user's intent can be readily inferred from the query itself, and the map simply has weather information included. On the other hand, where one or more entities are identifiable from the query, these entities may map to one or more intents. Thus, identification of the entity or entities may then inform the intent determination. According to various embodiments of the invention, entity identification and intent determination may inform one another, but are separate determinations, both of which may be implemented as machine learning systems. What is eventually presented in the map interface is based on the entity or entities identified and the correlated intent(s).

A particular entity or intent might also map to a number of different data sources from which relevant geo-related information may be derived for presentation on a map or in a map overlay. In such a case, the information presented on the map relating to a particular entity might be a “consolidated” view of that entity derived from multiple sources of data. For example, if a user searches for a particular address, information relating to that address from a variety of sources may be combined or federated in accordance with the user's perceived intent to provide useful information on the map that would otherwise not be included (e.g., real estate prices for that and nearby locations). Mapping between entities at the back end may also be leveraged to identify relevant information for presentation and/or to inform the intent determination. These and other variations are contemplated to be within the scope of the invention.

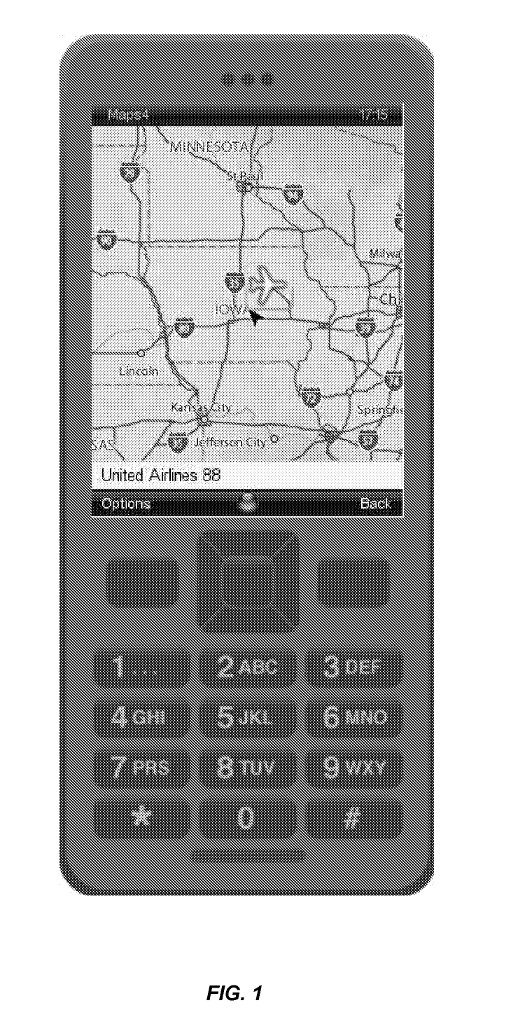

A wide variety of geo-related information and data types may be presented in map interfaces in accordance with the invention, e.g., geo-coded images, news stories, weather data, event information, etc.; any data or data source that can be associated with a geographic location or region. Examples of such geo-related information are shown in the mobile device screen shots of FIGS. 1-7. As will be discussed, the geo-related information displayed may include links to other information or data sources from which further geo-related information may be obtained. And as will become apparent, the quality of information presented in these examples is correspondingly enhanced relative to conventional approaches through the identification of entities and intent.

The screen shot of FIG. 1 illustrates the presentation of a search result on a map interface in response to a search query “UA 88.” As will be discussed in greater detail below, it was determined that this query mapped to the entity “United Airlines flight number,” and specifically, to flight number 88. The intent was determined to be that the user wanted to know the current status of that particular flight, so a representation of the airplane is presented at its current location. Selection of the airplane may result in further details for the depicted flight, e.g., departure or arrival time, whether there are any delays, etc. Selection of the airplane may also result in navigation to the appropriate page of the United Airlines web site.

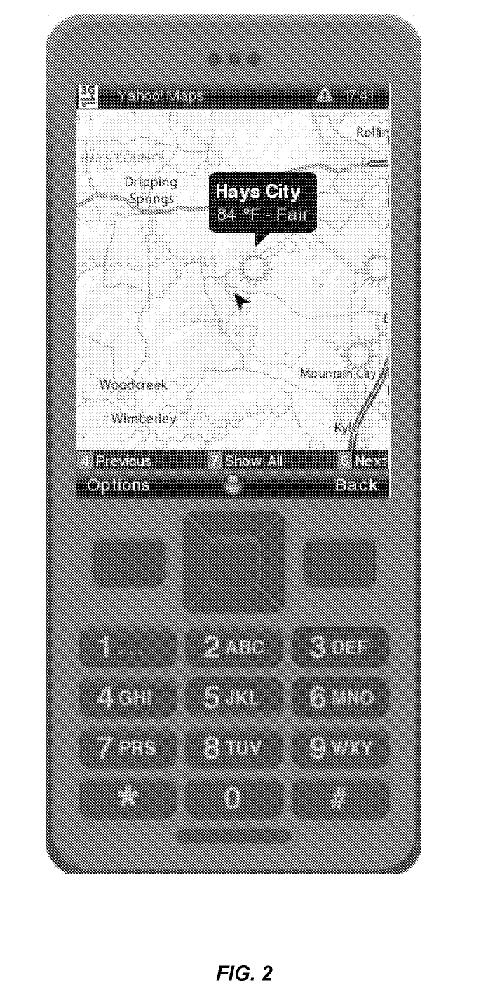

In another example shown in FIG. 2, the user enters the search query “weather” and search results are presented as representations of the current weather conditions, e.g., storm clouds, around the user's present location or some other specified location. Selection of the weather representations in the interface may then result in more detailed conditions and/or forecasts being presented and/or navigation to a weather-related site.

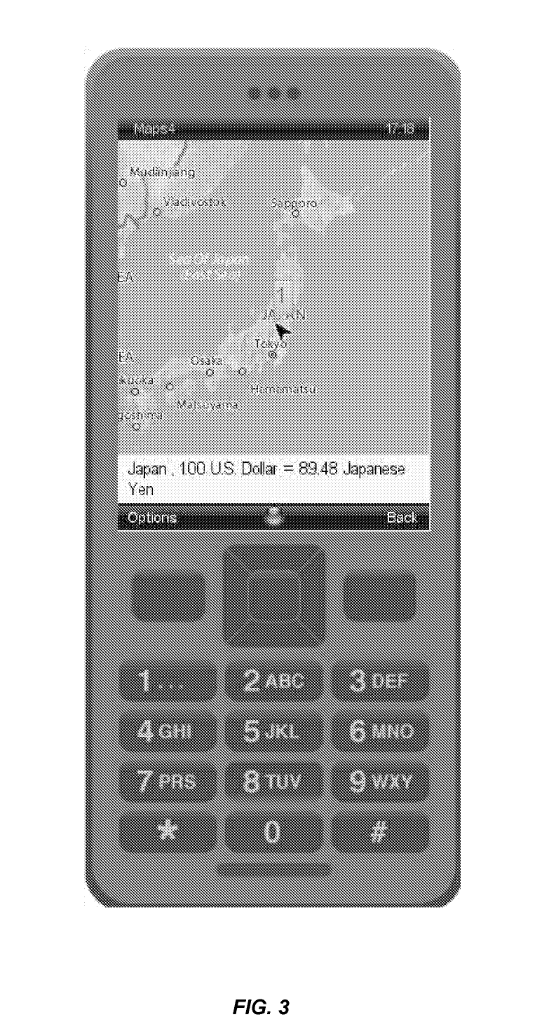

FIG. 3 shows an example in which the query “Japan” maps to the entity of the country of Japan which is presented in a map interface along with information, i.e., currency exchange rate, which might be relevant to the intent of the particular user. Selection of the overlaid icon may result, for example, in presentation of general information regarding the depicted country such as might be available on Wikipedia.

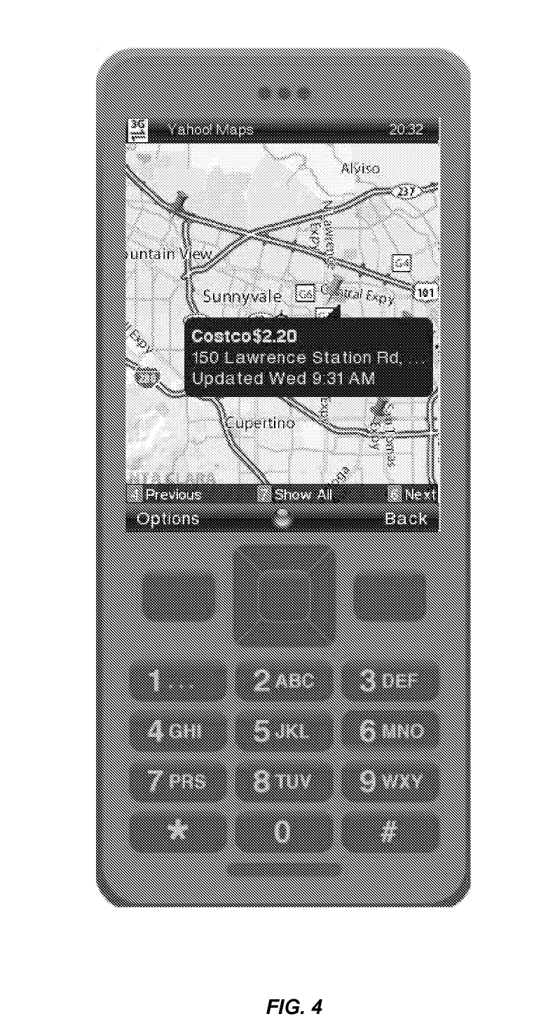

In FIG. 4, the search query “gas” is mapped to the entity gas station which results in presentation of a map interface identifying a number of gas station options near a particular location, e.g., the user's current location. Selection of or placement of the cursor over a particular option may result in identification of the brand, price per gallon, and address of the selected option.

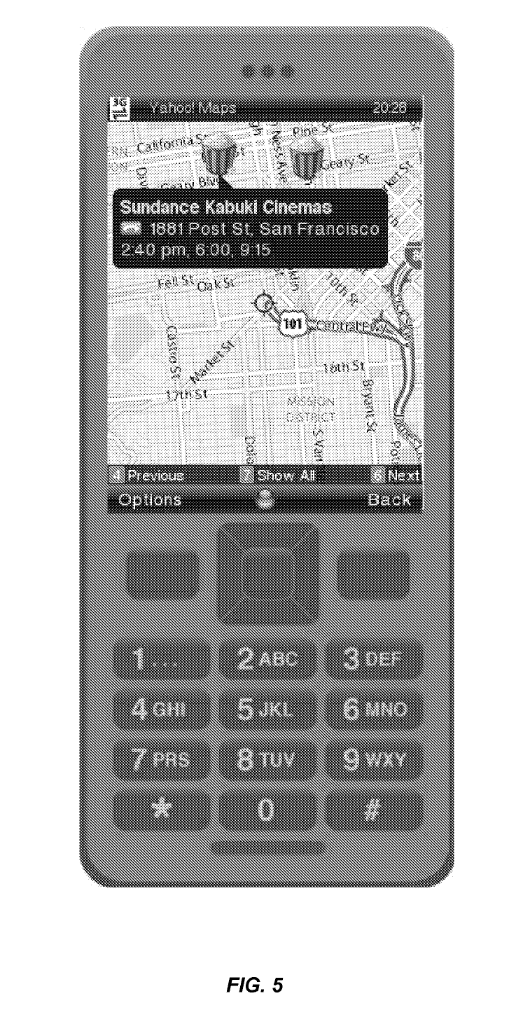

In FIG. 5, the search query “movies” maps to the entity movie theater which results in presentation of results representing nearby theaters. Selection of a particular result representation (in this case a tub of popcorn) results in presentation of more detailed information for the selected theater including, for example, movie listings and times.

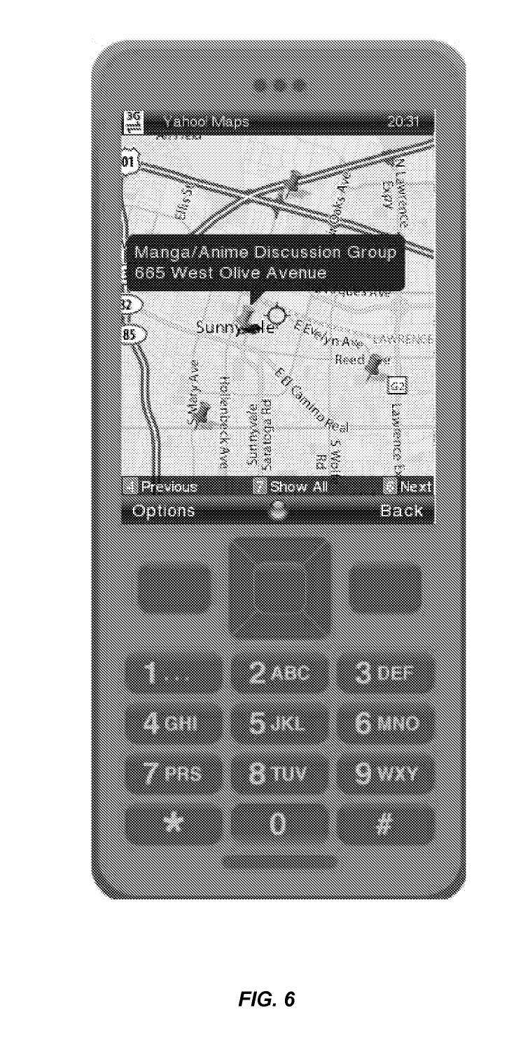

In response to the search query “events,” representations of upcoming events in a particular geographic area (e.g., defined by the user's home address) are presented in the example shown in FIG. 6. The particular events presented might be determined, for example, with reference to the requesting user, e.g., with reference to expressed user preferences, past online behavior, demographics, etc. Selection of one of the presented option may result, for example, in presentation of details of the event, navigation to a web site relating to the event, etc.

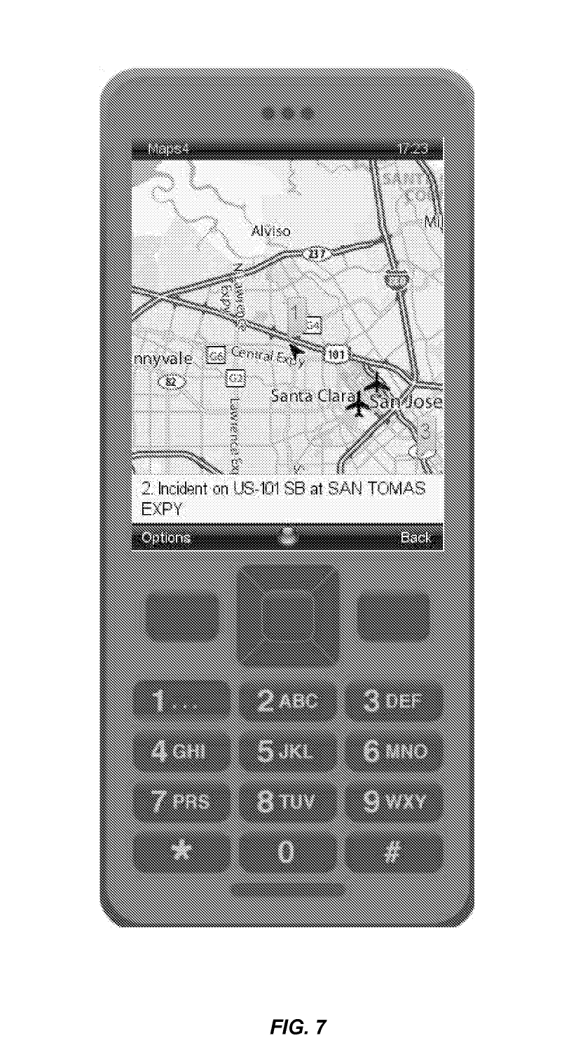

Finally, in FIG. 7, the search query “traffic” maps to the entity “current traffic incidents” which results in presentation of traffic incidents currently causing issues near the user's current location.

The information presented in each of the foregoing examples is informed by the understanding of the abstractions to which the entered query maps and the determination of the intent underlying the query. As discussed above, this enables the presentation of a much broader range of highly relevant results than conventional approaches to map search.

And, as also mentioned above and according to some embodiments, determination of a user's intent and/or identification of an entity or cluster of entities may be biased with reference to W4 metadata. That is, W4 metadata may reveal mappings to entities or information that may not have an obvious or first order relation to the user's intent. Using the example of a user searching for “weather,” if the geographic region is Monterey, California, the user is a golfer, and the weather is sunny, information relating to nearby golf courses might be presented.

This use of W4 metadata to enhance results may encompass, for example, an understanding of the things for which users of particular demographics or in particular geographic areas often enter queries, or what intents are often associated with particular queries or geographic locations. As will be understood, W4 metadata as well as other behavioral data aggregated over time may be leveraged in a wide variety of ways to identify geo-related information for presentation in accordance with embodiments of the present invention. Aggregated behavioral data may not only be used to generate results in particular instances, but may also be used to refine the results model and the intent model over time.

The relevant geographic location or region for a particular query may vary dramatically depending on the context and the query. That is, the geographic location that is relevant might be the user's current location, any of a variety of locations associated with the user (e.g., home, work, address book or calendar locations), a location that is the subject of the query, or even a location that is somehow implied by or related to the query. The query disambiguation capabilities of oneSearch may be employed to identify the most relevant geographic location in the particular instance.

Existing recommendation technology may also be leveraged to identify relevant geo-related information for display. For example, a user from Barcelona visiting San Francisco might be presented with recommendations or comments of other users from Barcelona for POIs in San Francisco. Alternatively, information relating to what other users corresponding to the user's demographic search for or have an interest in might be presented. More generally, item affinity and user affinity may be important factors in determining a particular user's intent for a given query.

In addition monetization opportunities may be realized in relation to the identification and presentation of geo-related information in accordance with various embodiments of the invention. For example, in cases where there are multiple data sources from which to derive geo-related information, a bidding model could be employed in which the data sources or business entities represented in the data can bid to have their data included or emphasized in results generated in accordance with the invention. In another example, a bidding model may be employed to inform the process by which entities get related to each other for possible representation in search results. Yet another bidding model might be employed to associate data sources with entities. A number of variations within the scope of the invention should become apparent with reference to these examples.

Advertising content may also be selected and presented in a manner similar to conventional search-based advertising models, but with reference to intent, entities, and/or location. For example, if the intent identified is “to travel,” rental car ads might be shown; if the intent is “find movie listings,” ads for nearby restaurants might be shown. Monetization may also be tied to selection of the information being presented in a map overlay as well as in connection with the presentation of the information. So, for example, a representation of a department store might be presented in response to a query regarding clothing. In addition, a link to a special offer or coupon for that department store might also be presented.

More generally, monetization opportunities and mechanisms may be mapped to query keywords, the user, the time, entities, user intent, geographic locations (e.g., any of the various types mentioned above), or any combination of these. Virtually any monetization mechanism employed with conventional search advertising may be leveraged and enhanced in the context of embodiment of the present invention.

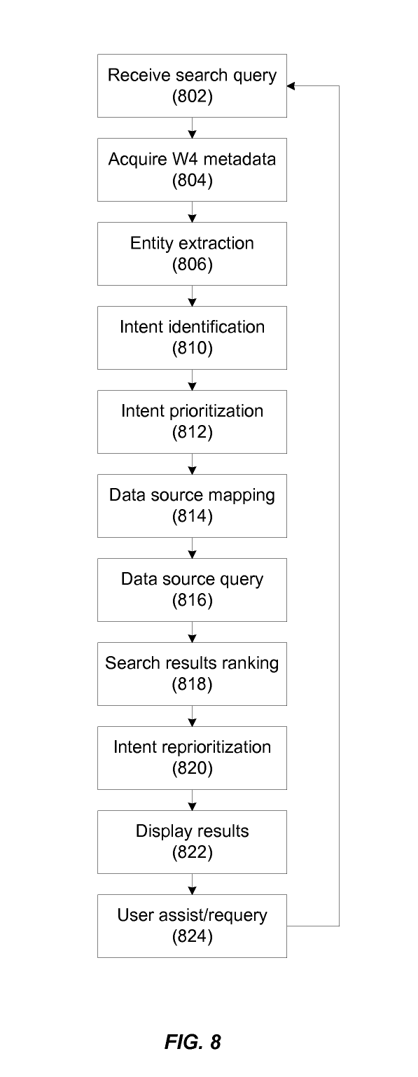

The operation of a specific embodiment of the invention will now be described with reference to the flowchart of FIG. 8. The user enters a query, e.g., “pizza chicago” (802). As mentioned above, W4 metadata may be employed at any point in the process to enhance performance. At least some W4 metadata may accompany or even precede the query (804). For example, the user's location may already be known from a variety of available location-related data, e.g., GPS position, nearby cell tower, etc. There are actually multiple types of location information that may be relevant in a given case. These include the location of the user, a location already indicated on the user's device, e.g., a displayed map, and a location explicitly or implicitly related to the user's query. The user's identity may also be known on some level, e.g., the user is logged into a particular site. Obviously the current time is available. And the subject matter of the query can be determined from the query itself. These data may then be used in entity extraction and intent identification to help with the determination as to what entities and intents are most likely indicated by the query. That is, any of these W4 metadata may be relevant to determining the entities to which the user's query may relate, and the intent behind the user's query, as well as other steps in the process.

Entity extraction (806) involves parsing of the query to identify any relevant entities. In this example, “pizza” is identified as a category of food and “chicago” is identified as a U.S. city in the state of Illinois. In addition, “Pizza Chicago” is identified as a business listing. Thus, three entities are readily identifiable from the query.

Entity mapping (808) involves associating a category with an entity. In this example, pizza Chicago falls within the restaurants category.

Intent identification (810) involves determining possible intent(s) for the extracted categories. Because the entity “Pizza Chicago” is a restaurant, the possible intents behind the user's query could be, for example, to identify nearby local business listings, to get driving directions, etc.

Intent prioritization (812) involves ordering the determined intents in terms of which are the most likely intents being expressed by the user. This may involve the use of a wide variety of data such as, for example, the past online behavior of users entering this query or similar queries mapping to the same entity or entities. According to some embodiments, only the most likely intent is selected. According to other embodiments, more than one intent may be considered important.

Data source mapping (814) involves identifying one or more data sources from which results corresponding to the determined intent(s) and/or entit(y/ies) are to be retrieved. That is, each intent identified maps to one or more data sources. For example, the intent “local business listings” might map to one or more directory data sources that include such listings. Similarly, entities may map to data sources from which data relevant to the identified entities may be obtained. So, for example, if a user enter “Yahoo,” there may be a number of different data sources from which relevant results might be obtained depending on the entities to which the term “Yahoo” corresponds. These data sources might include, for example, a database of business listings, various financial or business news sources, etc. Combinations of entities and intent may also be used to identify relevant data sources.

Data source query (816) involves applying the query to the data source(s) to which the intent(s) and/or entit(y/ies) map, following by a ranking of the retrieved results (818). In cases where multiple intents and/or entities are used to derive results from one or more data sources, the result rankings may relate to the priority of the intent and/or entity to which each result maps. For example, if the intent corresponding to “Pizza Chicago” has a higher priority than the intent corresponding to “pizza in Chicago,” a result corresponding to a geographically nearby Pizza Chicago restaurant would be ranked higher than a result for a pizza restaurant in the city of Chicago.

Intent reprioritization (820) involves reviewing the ranked search results and determining whether previous intent prioritization is valid in view of the types of results returned. For example, the primary data source provider for the current intent may return empty results set or indicate a low quality score for the results returned. In this case, the next best intent is used. That is, the returned results may overwhelmingly map to an intent that either hadn't been identified or was prioritized relatively low. This reprioritization may, in turn, affect the ranking of the returned results. Again, this part of the process may be informed by available W4 metadata.

Display results (822) involves presentation of the search results in a map interface such as, for example, shown in the mobile device screen shots of FIGS. 1-7. As will be understood, the map interface may be presented in virtually any kind of computing device or environment. In conjunction with presentation of the search results, the user may be given the option to revise the search. User assistance/re-query (824) involves communicating that the presented results were determined with reference to a particular user intent and/or identified entity, and providing some mechanism by which the user may provide feedback as to whether the assumed intent or entity were accurate, and/or additional information revising the query. The process may then be repeated using the new information.

As mentioned above, embodiments of the present invention may incorporate an awareness of geo-location into multiple parts of the process illustrated in FIG. 8 which, in combination with intent and/or entity identification, generates qualitatively different results than previous techniques which do not take the such information into account. Embodiments of the invention take any input, whether in a map context or not, and identify any of the multiple kinds of results which map to geo-location data corresponding to any of a number of possible intents behind that input. The process then disambiguates among the possible intents, and selects the results that are the most relevant.

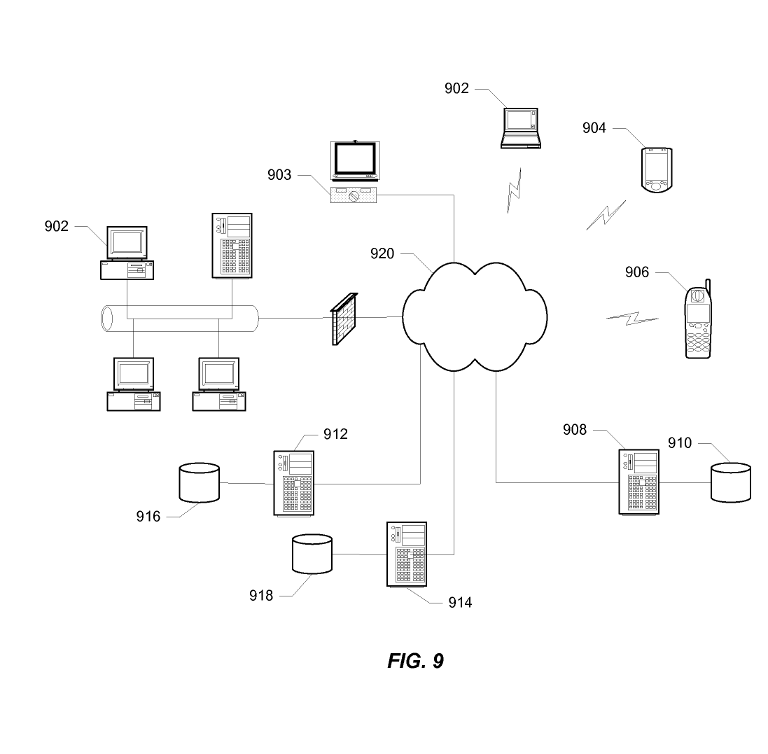

Embodiments of the present invention may be employed to generate and present geo-related search results in any of a wide variety of computing contexts. For example, as illustrated in the network diagram of FIG. 9, implementations are contemplated in which the relevant population of users interacts with a diverse network environment via any type of computer (e.g., desktop, laptop, tablet, etc.) 902, media computing platforms 903 (e.g., cable and satellite set top boxes and digital video recorders), mobile computing devices (e.g., PDAs) 904, cell phones 906, or any other type of computing or communication platform. Users may enter search queries and the geo-related search results may be presented using any of these types of devices.

According to various embodiments, W4 and other user-related data processed in accordance with the invention may be collected using a wide variety of techniques. For example, collection of data representing a user's interaction with a web site or web-based application or service (e.g., the number of page views) may be accomplished using any of a variety of well known mechanisms for recording a user's online behavior. User data may be mined directly or indirectly, or inferred from data sets associated with any network or communication system on the Internet. As mentioned above, relevant location or geographic information may be determined in a variety of ways such as, for example, using available functionality of the user's device (e.g., GPS, cell tower locations, etc.), inference from a search query, etc. And notwithstanding these examples, it should be understood that such methods of data collection are merely exemplary and that user data may be collected in many ways.

Search queries may be received and processed according to the invention in some centralized manner. This is represented in FIG. 9 by server 908 and data store 910 which, as will be understood, may correspond to multiple distributed devices and data stores. And the diverse data sources from which relevant search results are obtained may be similarly distributed as represented by servers 912 and 914 and associated data stores 916 and 918. The invention may also be practiced in a wide variety of network environments including, for example, TCP/IP-based networks, telecommunications networks, wireless networks, etc., and any combinations of these, which are represented by in FIG. 9 network 920.

In addition, the computer program instructions with which embodiments of the invention are implemented may correspond to any of a wide variety of programming languages and software tools, and be stored in any type of volatile or nonvolatile computer-readable storage media or memory device, and may be executed according to a variety of computing models including a client/server model, a peer-to-peer model, on a stand-alone computing device, or according to a distributed computing model in which various of the functionalities described herein may be effected or employed at different locations.

While the invention has been particularly shown and described with reference to specific embodiments thereof, it will be understood by those skilled in the art that changes in the form and details of the disclosed embodiments may be made without departing from the spirit or scope of the invention. For example, embodiments have been described with reference to the presentation of search results in map interfaces on mobile device displays. However, it will be understood that the scope of the invention is not so limited. That is, embodiments are contemplated in which such information is presented in virtually any type of display associated with virtually any type of computing device.

In addition, embodiments are contemplated in which the presentation of geo-related information according to some embodiments of the invention may not require initiation by the entry of a search query. That is, various “push” embodiments are contemplated in which such information is presented automatically such as, for example, when a user turns on or logs into a device or system. As with any of the other embodiments of the invention, the most relevant geo-related information can be determined with respect to any of a variety of information including, for example, W4 metadata as well as behavioral data of the particular user or a population of users. Finally, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for providing search services, comprising:
receiving a search query entered by a user on a remote computing device;
determining one or more entities corresponding to one or more abstract concepts represented by the search query, each entity having a geographic component;
determining one or more possible user intents represented by the search query;
identifying one or more data sources including search results data corresponding to a first one of the entities and a first one of the possible user intents;
retrieving a plurality of search results responsive to the search query, and relating to the first entity, and the first possible user intent from the one or more data sources;
relating representations of the search results to map information with reference to a specific geographic location; and
transmitting the representations of the search results and the map information to the remote computing device for presentation to the user.

2. The method of claim 1 wherein the specific geographic location is one of the group consisting of (1) a specified location specified by the user, (2) a current location of the user, or (3) a determined location of the remote computing device.

3. The method of claim 1 wherein the map information represents a map including the specific geographic location to be displayed on the remote computing device.

4. The method of claim 1 further comprising identifying a second data source and retrieving search results from the second data source, the second data source corresponding to one of the group consisting of (1) the first entity and the first possible user intent, (2) a second one of the entities and a second one of the possible user intents, (3) the first entity and a third one of the possible user intents, and (4) a third one of the entities and a fourth one of the possible user intents.

5. The method of claim 1 wherein contextual metadata associated with the user is used in one or more of (1) determining the one or more entities, (2) determining the one or more possible user intents, or (3) identifying the one or more data sources.

6. The method of claim 5 wherein the contextual metadata represents one or more of user information associated with the user, a social relationship associated with the user, a current geographic location associated with the user, a current time associated with the user, or a current topic associated with the user.

7. The method of claim 1 wherein the one or more possible user intents comprise a plurality of possible user intents, the method further comprising prioritizing the plurality of possible user intents to facilitate identification of the first possible user intent.

8. The method of claim 1 wherein the search query is received from a map search interface on the remote computing device.

9. The method of claim 1 wherein each of the representations of the search results comprises a graphical object that operates as a link to additional information for the corresponding search result.

10. A system for providing search services, comprising one or more computing devices configured to:
receive a search query entered by a user on a remote computing device;
determine one or more entities corresponding to one or more abstract concepts represented by the search query, each entity having a geographic component;
determine one or more possible user intents represented by the search query;
identify one or more data sources including search results data corresponding to a first one of the entities and a first one of the possible user intents;
retrieve a plurality of search results responsive to the search query, and relating to the first entity, and the first possible user intent from the one or more data sources;
relate representations of the search results to map information with reference to a specific geographic location; and
transmit the representations of the search results and the map information to the remote computing device for presentation to the user.

11. The system of claim 10 wherein the specific geographic location is one of the group consisting of (1) a specified location specified by the user, (2) a current location of the user, or (3) a determined location of the remote computing device.

12. The system of claim 10 wherein the map information represents a map including the specific geographic location to be displayed on the remote computing device.

13. The system of claim 10 wherein the one or more computing devices are further configured to identify a second data source and retrieve search results from the second data source, the second data source corresponding to one of the group consisting of (1) the first entity and the first possible user intent, (2) a second one of the entities and a second one of the possible user intents, (3) the first entity and a third one of the possible user intents, and (4) a third one of the entities and a fourth one of the possible user intents.

14. The system of claim 10 wherein contextual metadata associated with the user is used by the one or more computing devices to perform one or more of (1) determining the one or more entities, (2) determining the one or more possible user intents, or (3) identifying the one or more data sources.

15. The system of claim 14 wherein the contextual metadata represents one or more of user information associated with the user, a social relationship associated with the user, a current geographic location associated with the user, a current time associated with the user, or a current topic associated with the user.

16. The system of claim 10 wherein the one or more possible user intents comprise a plurality of possible user intents, the one or more computing devices being further configured to prioritize the plurality of possible user intents to facilitate identification of the first possible user intent.

17. The system of claim 10 wherein the search query is received from a map search interface on the remote computing device.

18. The system of claim 10 wherein each of the representations of the search results comprises a graphical object that operates as a link to additional information for the corresponding search result.

19. A computer program product for providing search services, the computer program product comprising at least one computer-readable storage medium having computer program instructions stored therein that are configured to be executed by at least one computing device, thereby causing the at least one computing device to:
receive a search query entered by a user on a remote computing device;
determine one or more entities corresponding to one or more abstract concepts represented by the search query, each entity having a geographic component;
determining one or more possible user intents represented by the search query;
identify one or more data sources including search results data corresponding to a first one of the entities and a first one of the possible user intents;
retrieve a plurality of search results responsive to the search query, and relating to the first entity, and the first possible user intent from the one or more data sources;
relate representations of the search results to map information with reference to a specific geographic location; and
transmit the representations of the search results and the map information to the remote computing device for presentation to the user.
